(19) United States
(12) Patent Application Publication
(10) Pub. No.: US 2011/0313875 A1
(43) Pub. Date: Dec. 22, 2011

(54) SYSTEM AND METHOD OF ORGANIZING SECURED PURCHASING GROUPS FOR BUYERS OF SIMILAR INTERESTS

(76) Inventors: Weihan Lin, Lisle, IL (US); Jian Tao, Lisle, IL (US); Weiying Lin, Glenview, IL (US); Chunfang Kang, Glenview, IL (US); Isabella Lin Kang, Glenview, IL (US)

(21) Appl. No.: 13/162,565

(22) Filed: Jun. 16, 2011

Related U.S. Application Data
(60) Provisional application No. 61/355,615, filed on Jun. 17, 2010.

(51) Int. Cl. G06Q 30/00; G06Q 40/00

(52) U.S. Cl. 705/26.1; 705/44

(57) ABSTRACT

This is a system and method of organizing secured purchasing groups (SPGs) to reduce costs and risks for both buyers and sellers by forming binding purchase offers and by selling in volume. The method includes authoring a first buyer to establish an SPG with the buyer's own terms of purchase. Other buyers join the established SPG if they agree to the terms of the SPG. As the established SPG interests more and more buyers and enlists the buyers to become a member, it attracts potential sellers to sell to the buyers of the SPG. A binding purchase contract is established when a seller makes a commitment to sell to a buyer of the SPG. A deposit is required from both the buyer and the seller to deter fraud and to reduce risks. A secret code system helps further reduce fraud and disputes. A user rating system further encourages good community behavior. The results of the rating system are used throughout the system.

### CROSS-REFERENCE TO RELATED APPLICATIONS

This application claims the benefit of U.S. Provisional Patent Application Ser. No. 61/355,615, filed Jun. 17, 2010, the entire content of which is herein incorporated by reference.

### FIELD OF THE INVENTION

The present invention relates generally to a system and method of electronic commerce and more particularly, to a system and method for organizing secured purchasing groups (SPGs) of secured purchase offers (SPOs) for desired goods or services and for facilitating the execution of the purchase offers.

### BACKGROUND OF THE INVENTION

Shopping via electronic communication networks, especially the Internet, has already become common practice among present-day shoppers. A lot of commerce systems have been created on the Internet, like buy.com, expedia.com, amazon.com, etc.

Internet provides the medium for users to communicate quickly, efficiently and cost-effectively. For instance, newsgroups applications allow users to create and subscribe to the news topic they are interested in.

Most systems for processing the sale of products are seller-driven, wherein the seller prices, packages, configures and offers the product for sale, and the buyer decides whether or not to accept the seller's offer. (amazon.com, buy.com, etc)

Some auction web sites, like ebay.com, allow individual users bid for goods or services, but does not allow buyers to form purchasing groups.

In some buying group systems, such as groupon.com, buyers are only offered a list of goods or services to choose from.

Priceline.com does not give buyers opportunity to rescind their conditional purchase offer (CPO) before sellers accept the offer. Sellers can, in theory, hold on to the CPO for unlimited time, thus giving sellers unfair advantage.

In some systems, CPO are only presented to a predefined group of sellers, leaving out a larger seller community. (priceline.com, groupon.com)

In some system, seller must accept all purchase offers of a purchasing group. In this situation, the quantity of the purchase offers may exceed seller's capacity and prevent some sellers from participating. (U.S. Pat. No. 6,260,024)

In some systems, buyers are even deterred from adjusting their purchase offer if no sellers accept their purchase offers. (priceline.com)

In some system, buyers are presented with a price to agree on. Buyers are deprived of the opportunities to use aggregate purchasing power to set the price. (U.S. Pat. No. 6,260,024)

It is sometimes very difficult to enforce the buyers to make payment. Or in the case of buyers already making commitment, it is difficult to enforce the seller to deliver the agreed-upon goods or services.

### OBJECTS AND ADVANTAGES OF THE INVENTION

It is an object of the present invention to provide system and method for organizing purchasing groups that permits any individual buyer to establish the buyer's own purchasing group or groups on the buyer's own terms of purchase.

It is another object to greatly increase the number of sellers. Anyone can be a seller, not limited to predetermined venders. This creates a competitive environment to the advantage of buyers.

It is a further object to provide individual buyers with a collective bargaining power.

It is a further object to deter fraud and reduce risks for both buyers and sellers, and thus reduce the cost of transactions and further lower prices.

It is a further object to further reduce a seller's inventory risks by knowing the exact volume of purchases before the seller builds up inventory.

It is a further object to reduce the time a buyer has to wait before a first seller appears by encouraging sellers to compete for the best buyers.

It is a further object to promote good community behavior by utilizing satisfaction score throughout the life of SPGs.

It is a further object to expand sellers' potential market by attracting price-conscientious buyers, who would only buy below certain price, to setup SPGs.

It is a further object to reduce delivery cost and credit card transaction fee by organizing geographically limited SPGs.

It is a further object to allow repetitive or periodic purchases (such as grocery) by organizing repetitive or periodic SPGs.

It is a further object to display updated purchasing group information in real-time for buyers and sellers to view from remote computers or terminals.

These and other objects and advantages of the present invention will become more apparent after consideration of the ensuing description and the accompanying drawings.

### DEFINITION

As used herein and in the claims, the following terms are defined to mean:

Secured Purchasing Group (SPG): a group of buyers with common purchase interests. Each buyer's deposit secures the buyer's membership in the group.

SPG Leader: A first buyer that establishes an SPG. In case a buyer does not find a suitable SPG in the system, the buyer can decide to establish a new SPG. When the buyer does so, the buyer becomes the leader of the SPG.

Terms of an SPG: The conditions of the purchase offer set forth by the SPG leader. The terms of an SPG include the specification of the goods or services, unit price, location of delivery, payment method, times and periods of repetitiveness and many other suitable conditions at the discretion of the SPG leader.

Secured Purchase Offer (SPO): The purchase offer that a buyer establishes when the buyer becomes a member of an SPG. When the buyer becomes a member of an SPG, the buyer effectively establishes a purchase offer with the same terms as the terms of the SPG. The buyer can specify additional conditions, such as quantity and a limited number of other conditions when the buyer joins the SPG. The buyer's deposit secures the buyer's purchase offer and the buyer's membership in the SPG. The offer is non-binding because the seller has not been identified. The buyer revokes the buyer's SPO when the buyer relinquishes the buyer's membership in the SPG.

Member of an SPG: a buyer that agrees to the terms of an SPG and joins the SPG. The buyer establishes a purchase offer by being a member the SPG. The buyer can relinquish the buyer's membership under certain conditions

Binding Purchase Contract (BPC): A legally binding contract between a buyer and a seller after the seller makes a commitment to sell to the buyer, who is a member of an SPG. The terms of the contract includes the terms of the SPG and additional terms specific to the buyer's individual SPO.

Buyer's Deposit: A hold on a portion of the funds in the buyer's account in the system when a buyer becomes a member of an SPG. The buyer secures the buyer's membership in the SPG with the deposit. The deposit is normally released back to the buyer's account when the buyer relinquishes the buyer's membership in the SPG or at the satisfactory execution of the BPC originated from the SPG. The range of the deposit amount can be between 0% and 100% of the purchase price.

Seller's Deposit: a hold on a portion of the funds in the seller's account in the system when a seller makes a commitment to sell to a buyer. There is one seller's deposit for each BPC. The seller secures with the deposit the seller's right to sell to the buyer of the BPC. There are many factors affect the amount of the deposit and in general the deposit is proportional to the buyer's deposit of the BPC. The seller's deposit is normally released back to the seller's account upon satisfactory execution of the BPC. The range of the deposit amount can be between 0% and 100% of the purchase price.

Buyer's Secret Code (BSC): a code in alphanumeric or other suitable forms that the buyer reveals to the seller when a BPC is executed to the satisfaction of the buyer. There is one BSC for each BPC. The seller uses the BSC to reclaim the seller's deposit.

Seller's Secret Code (SSC): a code in alphanumeric or other suitable forms that the seller reveals to the buyer when a BPC is executed to the satisfaction of the seller. There is one SSC for each BPC. The buyer uses the SSC to reclaim the buyer's deposit.

Conditional Deposit Release (CDR): the releasing of the user's counterparty's deposit by the user of a BPC if the counterparty also releases the user's deposit.

### BRIEF SUMMARY OF THE INVENTION

The system and method according to the present invention allow any buyer to inform a broad audience of sellers of the exact terms of purchase, and helps reduce risks (inventory risks, trust risks, fraud risks, etc.) for both the buyers and sellers.

According to one aspect of the invention, an SPG management system is disclosed for using a computer to maintain an SPG for at least one buyer of one or more goods or services, to present the SPG to at least one seller, and to establish a high trust level between the buyer and the seller (collectively, users) to successfully execute the transaction between the buyer and the seller. In a preferred embodiment, the activities are conducted over a computer network that includes a central controller, a plurality of remote computers, and communication lines connecting the remote computers to the central controller. Each user is provided with a user interface, preferably web pages in a web browser according to a preferred embodiment, to send requests to and receive responses from the central controller.

According to another aspect of the invention, any buyer can request the establishment of an SPG in the system and become the leader of the SPG. The request contains the complete terms of the SPG. Upon reception of the request from the buyer, the system uses the terms of the SPG to establish the SPG in the system, and presents the SPG to all users via the user interface.

According to still another aspect of the invention, the system receives a deposit from the buyer to secure the buyer's membership in the SPG. The buyer's purchase offer becomes a secured purchase offer (SPO).

According to still another aspect of the invention, the system provides a user with search services to find the SPG among a plurality of SPGs. The system may further be practiced by recommending other relevant SPGs and commercial or promotional announcements based on the user's search criteria.

According to still another aspect of the invention, a user can be configured to become an observer of the SPG. The system may further notify the user any changes to the SPG via email or other communication channels according to a preferred embodiment of the invention.

According to still another aspect of the invention, once a buyer finds the SPG, the system provides the buyer with a user interface for the buyer to inspect the terms of the SPG and to join the SPG. Upon reception of the buyer's joining request, the system takes a deposit (Buyer's Deposit) from the buyer's account to secure the buyer's membership in the SPG.

According to still another aspect of the invention, the buyer can relinquish the buyer's membership in the SGP. The system releases the buyer's deposit back to the buyer's account upon reception of the request as long as no seller has accepted the buyer's SPO.

According to still another aspect of the invention, the system removes the membership of each buyer in the SPG after the expiration of the SPG. The system then releases the deposit of each buyer of the SPG back to the buyer's account.

According to still another aspect of the invention, once a seller finds the SPG and agrees to the terms of the SPG, the seller can select all (or a subset) of the buyers in the SPG to sell to. Upon reception of the seller's selection criteria, the system selects the buyers according to the criteria and establishes a binding purchase contract (BPC) between the seller and each of the selected buyers. The system accepts various selection criteria, including the buyers' rating, the buyers' deposit amount and many suitable criteria.

According to still another aspect of the invention, the system takes from the seller a deposit (Seller's Deposit) for each of the BPCs and use the deposit to secure the seller's right to sell to the selected buyer. The system uses many criteria, such as seller's average score, according to a preferred embodiment, to determine the seller's deposit amount.

According to still another aspect of the invention, the system can act, at the request of either parties of the BPC, as payment intermediary between the buyer and the seller.

According to still another aspect of the invention, when the buyer makes a full payment to the seller, the seller gives the seller's secret code (SSC) to the buyer. The system provides the buyer with a user interface to enter SSC into the system. The system releases the buyer's deposit to the buyer's account upon reception and successful verification of the SSC.

According to still another aspect of the invention, when the seller successfully delivers the goods or services to the buyer, the buyer gives the buyer's secret code (BSC) to the seller. The system provides a user interface to the seller to enter the BSC into the system. The system releases the seller's deposit back to the seller's account upon reception and successful verification of the BSC.

According to still another aspect of the invention, the system releases the counterparty's deposits if both of the parties of the BPC request to release the counterparty's deposit. The said release of deposit is called conditional deposit release (CDR). CDR may be used in situation when the BPC is not executed to its completion and in many other circumstances. The execution of the release of the counterparty's deposit is dependent on that the counterparty also sends a request of the same kind.

According to still another aspect of the invention, the system gives the user opportunities to assign a satisfaction score to the counterparty of the BPC. The system uses the score to conduct future SPG activities.

According to still another aspect of the invention, the system may further be practiced by rewarding the SPG leader monetarily or by other means after satisfactory execution of the BPC, which is originated from the SPG.

### BRIEF DESCRIPTION OF THE SEVERAL VIEWS OF THE DRAWING

The foregoing features and other aspects of the present application are explained in the following description taken in connection with the accompanying drawings in which like numbers refer to the like parts throughout the different views:

FIG. 1 is a block diagram illustrating major elements in one embodiment of the present invention;

FIG. 2 is a block diagram illustrating elements of the central controller in one embodiment of the present invention;

FIG. 3 is a flow chart illustrating one embodiment for the establishment of a SPG;

FIG. 4 is a flow chart illustrating one embodiment for making a buyer's deposit or seller's deposit;

FIG. 5 is a flow chart illustrating one embodiment for establishing a buyer's membership in an SPG;

FIG. 6 is a flow chart illustrating one embodiment for removing a member from an SPG;

FIG. 7 is a flow chart illustrating one embodiment for establishing a binding purchase contract between a seller and each of all or a subset of the members of an SPG;

FIG. 8 is a flow chart illustrating one embodiment for releasing deposits after satisfactory execution of a binding purchase contract;

FIG. 9 is a flow chart illustrating one embodiment for assigning satisfaction score to each party of a binding purchase contract;

FIG. 10 is a flow chart illustrating one embodiment for conditionally releasing counterparty's deposit; and

FIG. 11 SPG is a flow chart illustrating one embodiment for dissolving an expired SPG.

### DETAILED DESCRIPTION OF THE INVENTION

As used in the description herein and throughout the claims, the following terms take the meanings explicitly associated herein, unless the context clearly dictates otherwise: the meaning of “a,” “an,” and the includes plural reference, the meaning of in includes in and “on.”

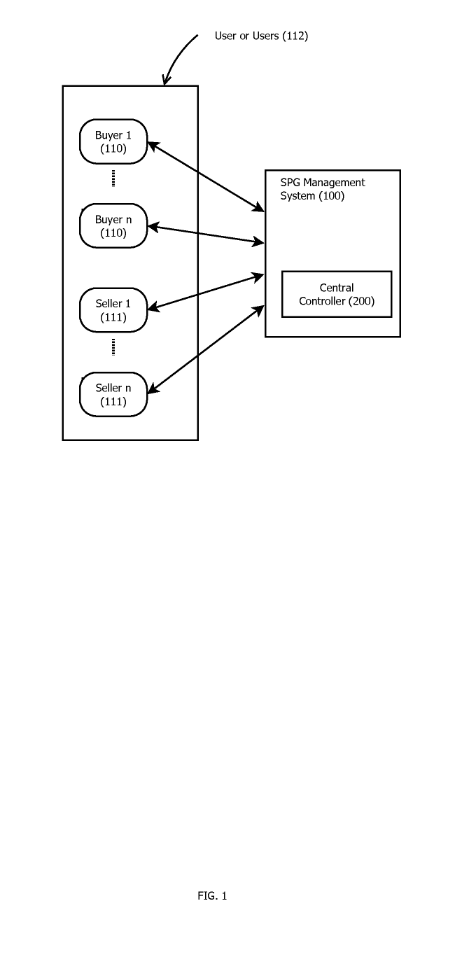

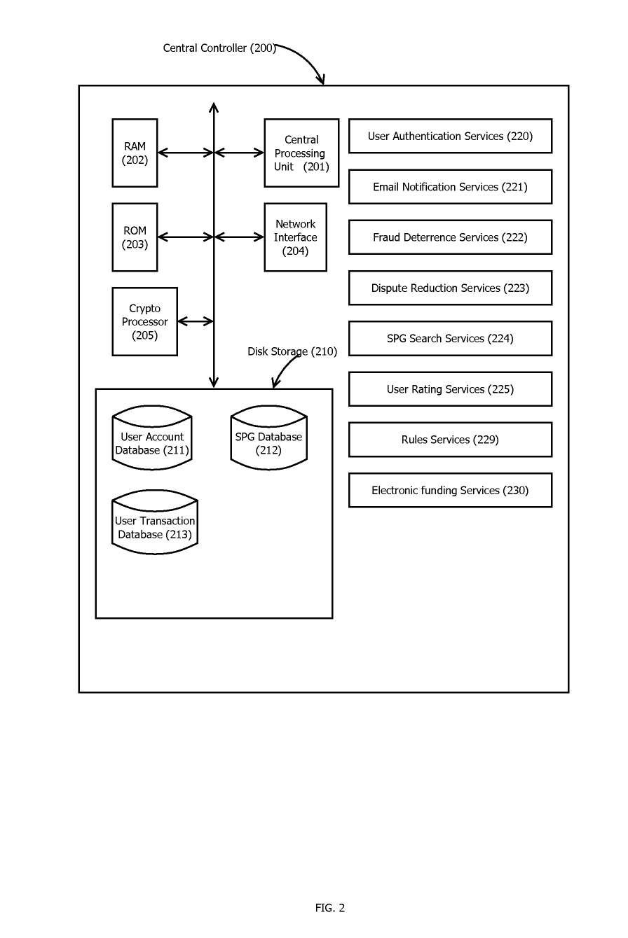

FIG. 1 shows one embodiment of a secured purchasing group (SPG) management system 100 connected to buyers 110 and sellers 111 (collectively users 112) for receiving and processing each request from one or more buyers 110 to establish, search for or join an SPG via a communication network, preferably the Internet. The SPG management system 100 also receives and processes each request from one or more sellers 111 to sell to buyers of the seller's choice. Once a seller accepts a buyer's SPO, the SPG management system binds the buyer and the seller to form a legally binding purchase contract. The SPG management system 100 includes a central controller 200, discussed further below in conjunction with FIG. 2.

As discussed further below, the user 112 contacts the SPG management system 100, for example, by means of electronic network and electronic mail. The user may preferably employ a general-purpose computer for communicating with the SPG management system 100. Though not illustrated, the general-purpose computer is preferably comprised of a processing unit, a communication device (e.g. a wireless network card), memory, web browser software any software required to communicate with the SPG management system.

The SPG management system 100 and any general purpose computers utilized by users 112 preferably transmit digital signal and data by means of a digital communication network, which includes physical links, for example, a cable or wireless link.

FIG. 2 is a block diagram showing the architecture of a preferred embodiment of central controller 200. The central controller 200 includes certain standard hardware components, such as a central processing unit (CPU) 201, a random access memory (RAM) 202, a read only memory (ROM) 203, a network interface 204, a data storage device 210. The CPU 201 is linked to each of the other listed elements, either by means of dedicated connections or, a shared data bus, as shown in FIG. 2. The network interface 204 connects the central controller 200 to each user 112.

The data storage device 210 includes at least a user account database 211, an SPG database 212 and a user transaction database 213. The user account database 211 stores information of each user of the SPG management system 100, including identification information, email address, geographic location, preferred language and financial information, such as a credit card number. The SPG database contains a record of each SPG established by a buyer and identification, status and purchase offer information of each buyer that joins the SPG. The user transaction database 213 contains a record of each BPC between a buyer 110 and a seller 111.

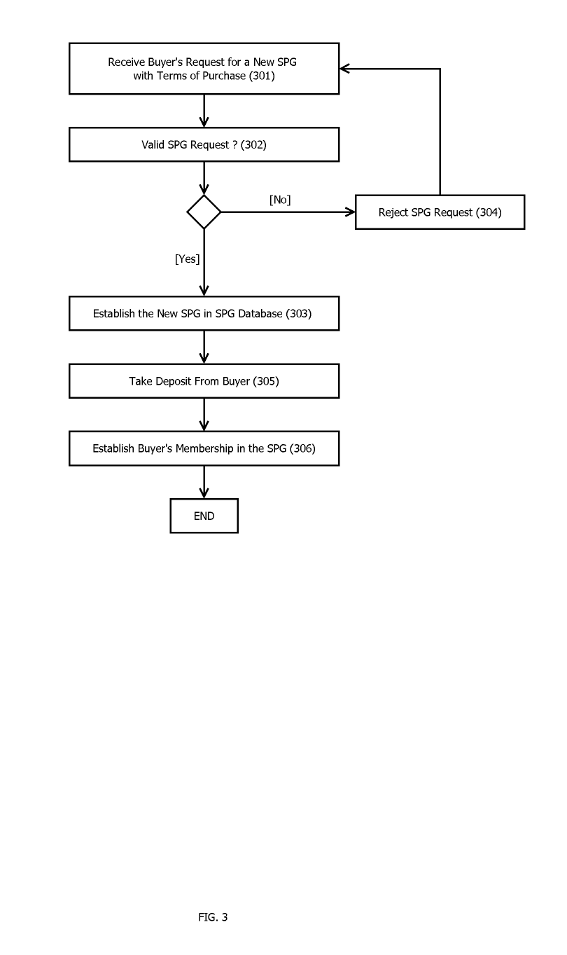

The central controller also includes a plurality of services, for example SPG search services 224, rules services 229, fraud deterrence services 222. The functionality of the services is discussed further below in conjunction with FIG. 3 through FIG. 10.

While the above embodiment describes a single computer, those skilled in the art will realize that the data, services and functionality can be distributed, combined and replicated among a plurality of computers over geographically diverse locations. This distributed arrangement yields a more load-balanced system less prone to catastrophic hardware failures affecting the entire system. The system configuration illustrated in FIG. 2 and described above is provided primarily to facilitate an understanding of system 200, and should not be construed as a limitation of system 200.

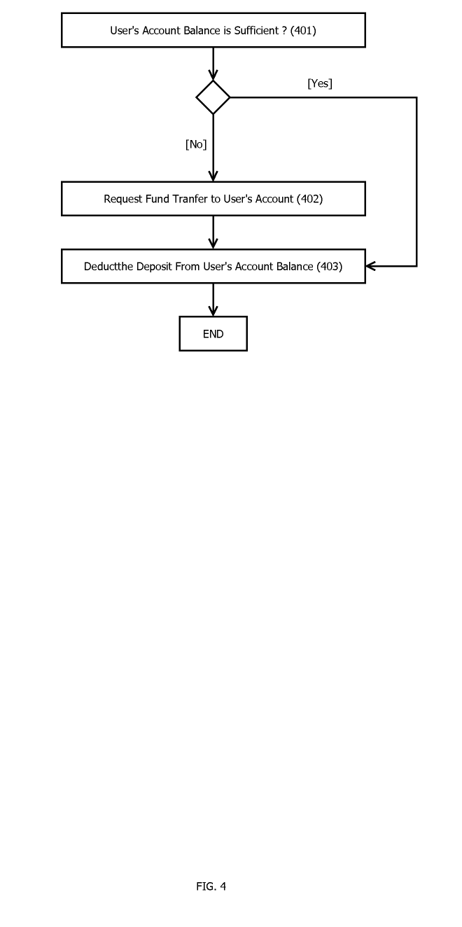

FIG. 3 illustrates an embodiment of the method to establish an SPG in the SPG management system 100. The system 100 receives a request from a buyer 110 of particular goods or services to create a SPG with particular terms. The terms may include the specification of goods and services, unit price, geographic location, delivery method, times or periods of repetitive purchases (for repetitive or periodic purchases, like grocery) and other suitable conditions at the discretion of the buyer. The system 100 uses fraud deterrence services 222 to verify the validity of the request according to the rules stored in the rules services 229. The system either accepts or rejects the SPG request, depending on the result of the verification. After a satisfactory verification, the system 100 establishes the requested SPG in SPG database 212. The system 100 takes a deposit from the user account (The deposit process is discussed further below in conjunction with FIG. 4). The system then records the buyer's membership of the new SPG in the SPG Database 212.

FIG. 4 shows an embodiment of a method of taking a deposit from the user. If the balance is not sufficient to cover the deposit, the system provides an interface for the user to transfer funds to the user's account. If sufficient fund is available in the user's account, the system deducts the deposit amount from the user's account balance and record the deposit in SPG database 212. The source of the funds can be a credit card, a bank account, a debit card, a money order, a check, PayPal, or other sources. The system provides a user interface for users to view their account status and balance at any time. Users may deposit or withdraw their money at any time but may only withdraw up to balance amount in the account.

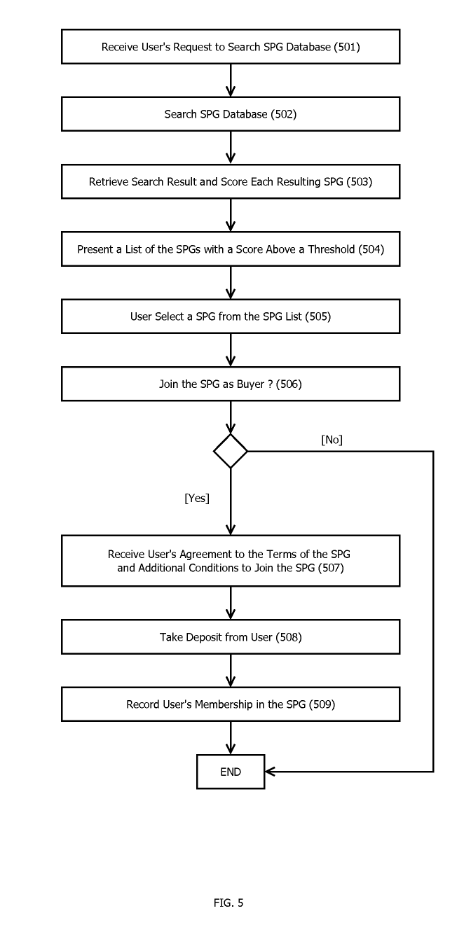

FIG. 5 illustrates an embodiment of the method of assigning membership of an existing SPG to a buyer. The system 100 provides each potential buyer 110 with the capability of searching or browsing existing SPGs. The system receives the user's search query, searches the SPG database 212 and transmits the search result to the user. The search result includes zero, one or more SPGs and each of the SPGs is assigned a score according to its relevance to the search query. The system presents to the user each SPG with a score above a threshold. The system transmits the detailed information of the SPG after the buyer selects an SPG that the buyer is most interested in. At this point the buyer may decide whether to join the SPG or not. If the buyer determines to join the SPG, the system receives from the buyer the buyer's agreement to the terms of the SPG and the buyer's additional conditions of purchase, such as purchase quantity, deposit amount, etc. The system records the received information, takes a deposit (Buyer's Deposit) from the buyer's account and records the buyer's membership of the SPG in the SPG database 212.

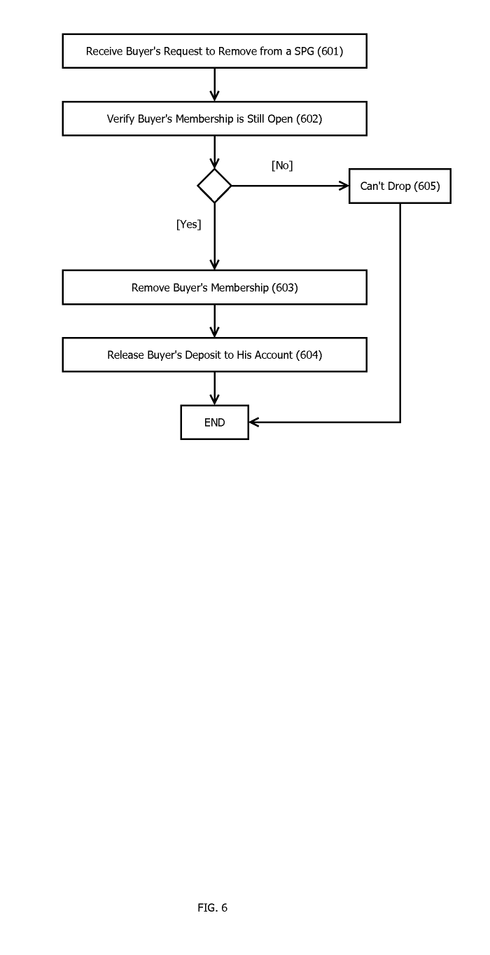

FIG. 6 illustrates an embodiment of the method of remove the buyer's membership from a SPG. After becoming a member of the SPG, the buyer may decide not to buy the goods or services specified in the SPG and may requests to relinquish the buyer's membership in an SPG. Upon reception of the buyer's request, the system verifies the membership is still open, i.e. there is no seller responds to the buyer's purchase request and the buyer has not previous relinquished the buyer's membership. Upon satisfactory verification, the system removes the buyer's membership from the SPG, records the removal in the SPG database 212 and then releases the buyer's deposit back to the buyer's account.

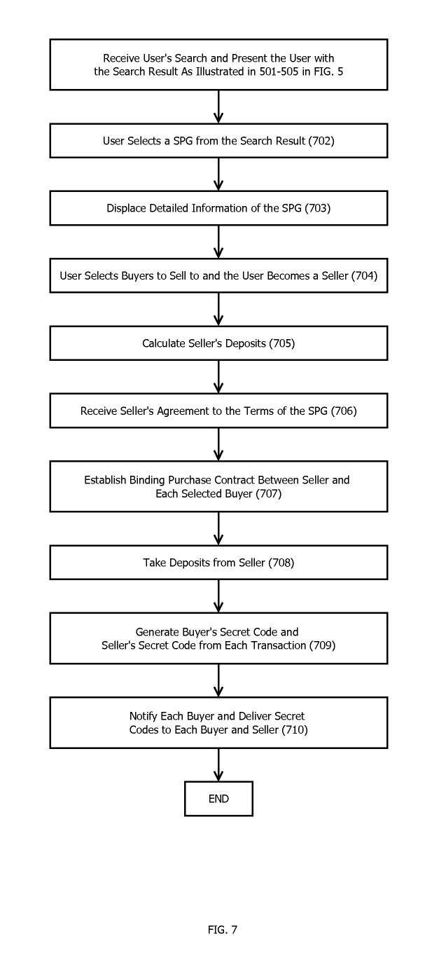

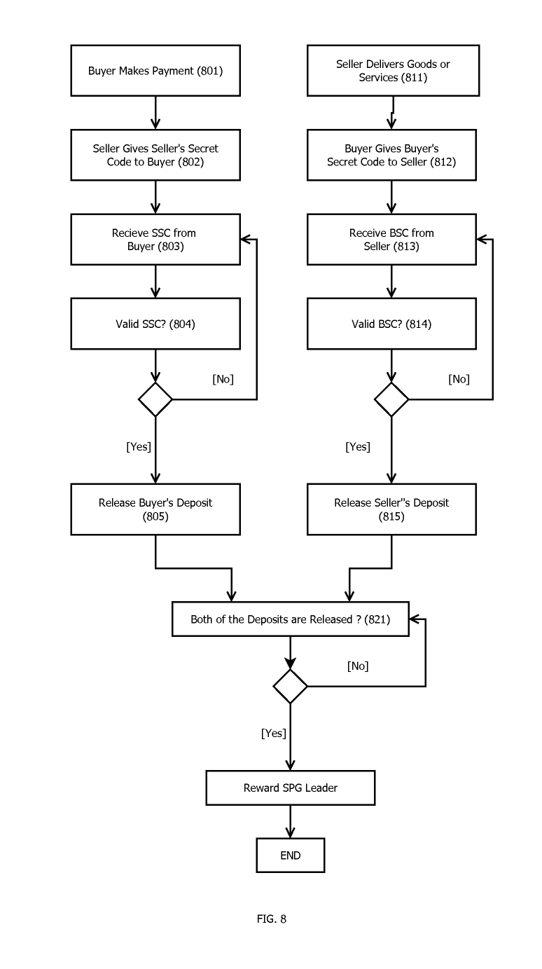

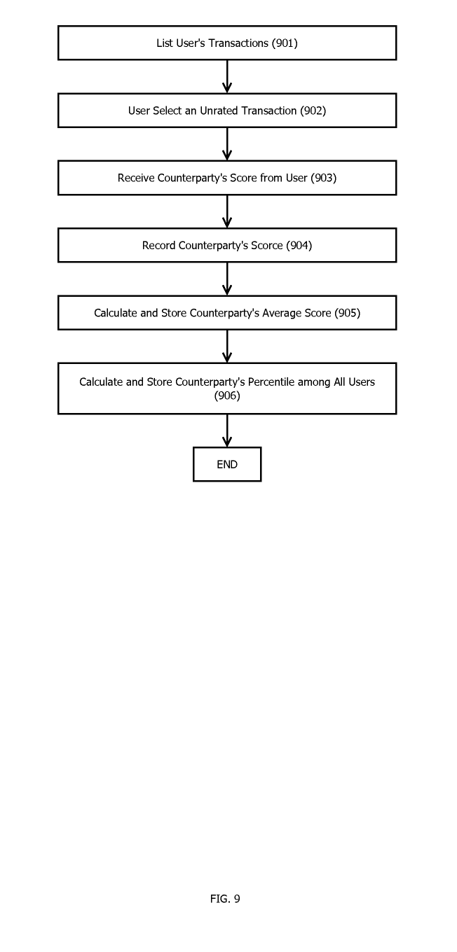

FIG. 7 illustrates an embodiment of the method of selling to an SPG. The system provides each potential seller an interface to search or browse existing SPGs. When the seller finds an SPG that the seller wants to sell to after inspecting the terms of the SPG, the seller instructs the system to select, with the seller's selection criteria, all or a subset of buyers from the SPG. The selection criteria may comprise buyers' rating, buyers' deposit and many other factors. Once the system finishes the selection on behalf of the seller, the system calculates and presents the seller's total deposit amount the seller must deposit. The total deposit amount depends on the seller's rating, individual buyers' deposit amounts and many other factors. Upon reception of the seller agreement to the total deposit amount and the terms of the SPG, the system establishes a binding purchase contract (BPC) between the seller and each of the selected buyers and deducts the total deposit amount from the seller's account balance. The established BPCs are recorded in the user transaction database 213. The system then sends the buyer's secret code (BSC) of each BPC to respective buyers and sends the seller's secret code (SSC) of each BPC to the seller via suitable electronic or other channels. The BSC and SSC are used in the deposit releasing method, discussed further below in conjunction with FIG. 8. The system according to the invention provides incentive for both the buyer and the seller to maintain a high average score (The scoring method is discussed further below in conjunction with FIG. 9). If the buyer's average score is high, the seller is likely to satisfy the buyer's purchase offer. If the seller's average is high, the seller's deposit amount can be lowered.

FIG. 8 illustrates an embodiment of the method of releasing the buyer's deposit and the seller's deposit and rewarding the SPG leader. After the BPC between a buyer and a seller is established, the buyer is responsible for paying the seller, and the seller is responsible for delivering the goods and services according to the terms of the SPG upon reception of the payment. Either of the users can choose the system 100 as payment intermediary or the buyer can optionally pay the seller directly if both parties choose this option. Once the seller receives the payment from the buyer, the seller renders the SSC to the buyer. The system provides the buyer with a user interface to enter the SSC into the system. The seller can also enter the SSC into the system via a user interface provided by the system. Upon reception and successful verification of the SSC, the system releases the buyer's deposit to the buyer's account. In case that the system acts as payment intermediary, the system immediately releases buyer's deposit to buyer's account upon reception of the buyer's payment.

Upon successful delivery of goods or services, the buyer renders the BSC to the seller. The system provides the seller with a user interface to enter the BSC into the system. The buyer can also enter the BSC into the system via a user interface provided by the system. Upon reception and successful verification of the BSC, the system releases the seller's deposit to the seller's account.

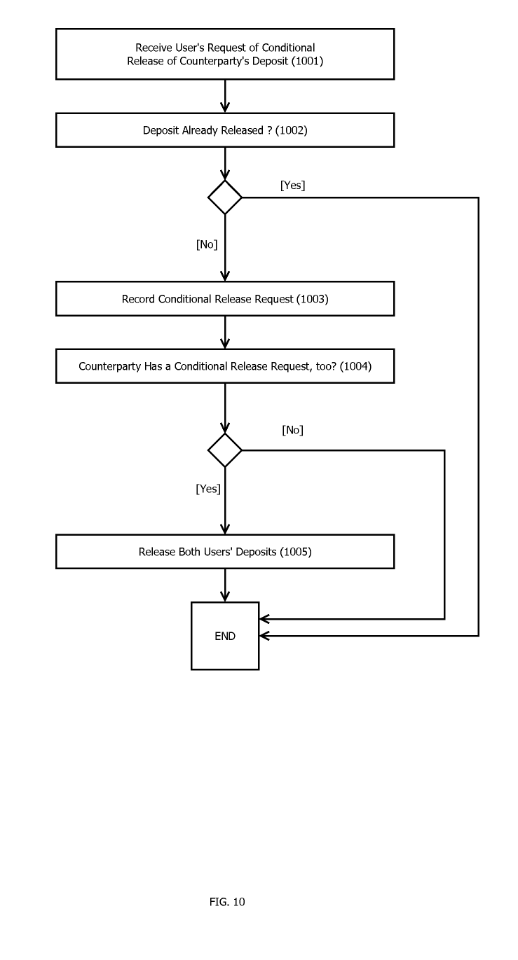

Many suitable manners can be employed to resolve failed transactions, depending on various circumstances. The faulty party typically forfeits the faulty party's deposit. Both the buyer and the seller can protest. The buyer and the seller are provided an opportunity to resolve the dispute, for example, by arbitration or many other means. In situations where nobody is at fault, the system releases the deposits back to the buyer's or the seller's accounts after a thorough review. The buyer and the seller can also resolve their dispute between themselves and release their counterparty's deposit via conditional deposit release, discussed further below in conjunction with FIG. 10.

FIG. 8 further illustrates an embodiment of the method of rewarding the SPG leader. Upon verification of the release of both users' deposit, the system rewards the SPG leader monetarily or by other means.

FIG. 9 illustrates an embodiment of the method of assigning a satisfaction score to the users of the BPC. Once the BPC is established, the system gives both the seller and the buyer an opportunity to rate their counterparty. The system receives and records the score. It calculates an average score based on user's historical scores. It also calculates user's standing (e.g. percentile) among a group of users.

FIG. 10 illustrates an embodiment of the method of releasing deposits conditionally. In situations when the user only wants to release the user's counterparty's deposit if the user's counterparty does the same, the user can use conditional deposit release (CDR). The system receives a CDR request from the user. If the user's counterparty's deposit has not been released, the system records the request. The system then verifies whether the counterparty also has a CDR request pending. If yes, the system releases both parties' deposits to their respective accounts.

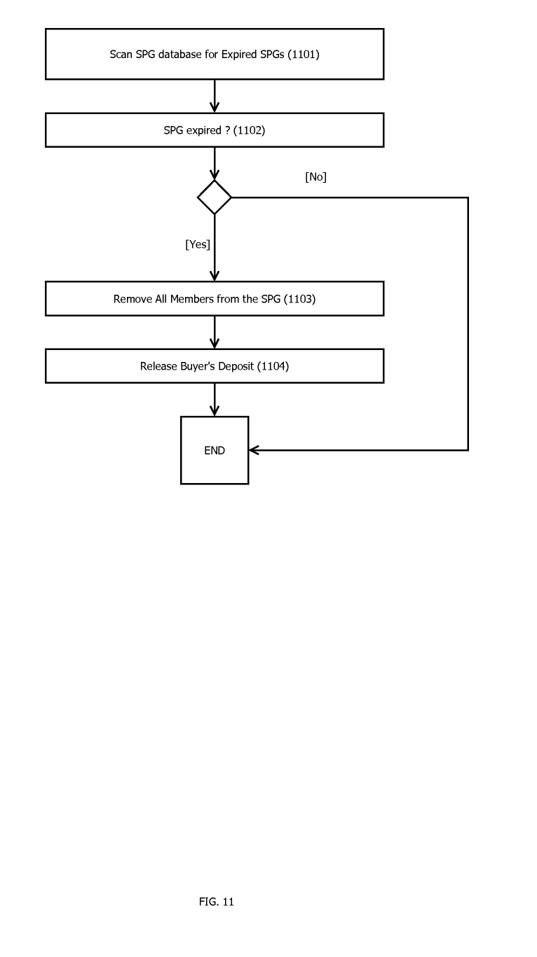

FIG. 11 illustrates an embodiment of the method of dissolving an expired SPG. The system periodically scans the SPG database to detect expired SPGs. Upon detection of an expired SPG, the system removes each buyer's membership in the SPG and then releases the buyer's deposit back to the buyer's account.

In a particularly advantageous embodiment, the method also includes the step of creating a user account for each user. The user account includes user's identification code, email address, geographical location, financial account information, etc. The account can also function as a funding account for deposit purpose.

In a particularly advantageous embodiment, the method also includes the step of add a user as an observer of an SPG. The system notifies the observing user of the predetermined changes of the SPG via email or other communication channels.

While there have been illustrated and described what are considered to be preferred specific embodiments of the present invention, those skilled in the art will recognize that the present invention is not limited to the specific embodiments thereof, and will be able to make modifications and adaptations therein without departing from the spirit and scope of the present invention.

We claim:

1. A method of organizing secured purchasing groups (SPG) using a computer system over a global network, comprising:
(a) establishing and maintaining user accounts in said computer system;
(b) transferring funds between user accounts and other funding source via said computer system;
(c) establishing a SPG for a first buyer on said computer system;
(d) browsing and/or searching the said computer system for SPGs based on key words, price range, geographic locations or other parameters supplied by a or a plurality of potential users;
(e) accepting SPOs of a or a plurality of second buyers to said SPG on said computer system;
(f) removing said SPO from said SPG on said computer system if said buyer decides to cancel said SPO before a seller accepts said SPO;
(g) if a seller accepts a or a plurality of said SPOs of said SPG, creating a or a plurality of binding purchase contracts (BPC) whereas each of said BPCs binds said seller to each of said SPOs, respectively;
(h) releasing deposits to users' account on said computer system;
(i) receiving and recording the user's satisfaction score on the counterparties of said BPC;
(j) rewarding SPG leader with a percentage of the price of satisfactorily executed BPCs; and
(k) expiring said SPOs not accepted by a seller if said SPG reaches its expiration date.

2. The method according to claim 1, wherein step (c) further comprises the steps of
(a) receiving from the first buyer at least one parameter of a price, a delivery method, a geographic area, a description, terms and conditions, and frequency if said SPG is a recurring SPG; and
(b) validating said parameters.

3. The method according to claim 1, wherein step (c) and step (e) further comprise receiving additional parameters of said SPOs, such as quantity and deposit amount.

4. The method according to claim 1, wherein step (c), step (e) and step (g) further comprise receiving a deposit from said user's account or other funding sources.

5. The method according to claim 1, wherein step (c) further comprises providing said SPO to said user to review prior to recording said SPO in said computer system.

6. The method according to claim 4, wherein said computer system verifies sufficiency of said user's fund in said user's account.

7. The method according to claim 1, wherein step (f) further comprises returning the deposit of said buyer to buyer's account.

8. The method according to claim 1, wherein step (g) further comprises the steps of
(a) receiving said seller's selection of SPOs from said SPG based on said buyer's rating, deposit amount and/or other suitable factors;
(b) determining seller's deposit based on said buyer's deposit, seller's rating and/or other suitable factors;
(c) providing details of selected SPOs to said seller for review;
(d) receiving confirmation of said selection from said seller;
(e) storing said BPCs in said computer system;
(f) generating a buyer's secret code (BSC) and a seller's secret code (SSC) for each of said BPCs;
(g) storing said secret codes in said computer system;
(h) delivering said BSC and a certificate of each of said BPCs to said buyer of each of said BPCs, respectively, via email or other appropriate ways of communication; and
(i) delivering said SSC and a certificate of each BPC to said seller of each of said BPCs, respectively, via email or other appropriate ways of communication.

9. The method according to claim 1, wherein step (h) further comprises:
(a) If said users choose to exchange secret codes,
(a1) receiving said SSC from said buyer;
(a2) comparing said SSC with corresponding BPC's SSC stored in said computer system;
(a3) return said seller's deposit to said seller's account if step (a2) yields a positive match;
(a4) receiving BSC from said seller;
(a5) comparing said BSC with corresponding BPC's BSC stored in said computer system; and
(a6) return buyer's deposit to buyer's account if step (a5) yields a positive match; or
(b) if said users choose not to exchange secret codes,
(b1) receiving from said buyer an instruction of conditionally releasing the deposit of said seller of said BPC;
(b2) receiving from said seller an instruction of conditionally releasing the deposit of said buyer;
(b3) if both steps (b1) and (b2) are performed, returning the deposit of said seller to his account in said computer system and returning the deposit of said buyer to his account in the said computer system;
(b4) returning the deposit of said seller to his account in said computer system if step (b1) is performed and if the deposit of said buyer has already been returned to his account in said computer system; and
(b5) returning the deposit of said buyer to his account in said computer system if step (b2) is performed and if the deposit of said seller has already been returned to his account in said computer system.

10. The method according to claim 1, wherein step (i) further comprises calculating average score of satisfaction of each user and the percentile of the user's average score among all or a group of users.

11. The method according to claim 1, wherein step (d) further comprises transferring search result or other commercial announcements based on the interest of said user to said user's device for display.

12. The method according to claim 1, wherein step (k) further comprises returning deposits of buyers of said SPOs to said buyers' accounts.

13. The method according to claim 1, further comprises transferring search result, commercial announcements, recommendations, account information, SPO and SPG status, transaction status, feedback, and other information via global networks to the user device for consumption.

14. The method according to claim 8, wherein step (f) further comprises:
(a) using a pseudo random number generator;
(b) using a universally unique identifier generator;
(c) using SHA1 hash functions;
(d) using MD5 hash functions;
(e) using other suitable random number generators;
(f) using other suitable hash functions; or
(g) using other suitable cryptographic functions.

15. The method according to claim 8, wherein step (h) and step (i) further comprises:
(a) presenting said certificate in ISO 32000-1:2008 (Portable Document Format, PDF) or other suitable formats; and
(b) presenting said secret code in a barcode format or other suitable code presentation.

16. A method of returning deposits to users using a computer system over a global network, comprising:
(a) receiving a deposit from a first user of a transaction;
(b) transferring the amount of said deposit from the account of said first user in the said computer system or from other funding sources of said first user to a custodian account;
(c) receiving a deposit from a second user that is a counterparty of said first user in said transaction;
(d) transferring the amount of said deposit of said second user from the account of said second user in the said computer system or from other funding sources of said second user to said custodian account or to a separate custodian account;
(e) generating a first secret code and storing said first secret code in said computer system;
(f) generating a second secret code and storing said second secret code in said computer system;
(g) delivering said first secret code to said first user by means of email or other suitable ways of communication;
(h) delivering said second secret code to said second user by means of email or other suitable ways of communication;
(i) instructing said users to exchange said secret codes when they are satisfied with said transaction;
(j) receiving said second secret code from said first user and comparing said second secret code with said second secret code stored in the said computer system;
(k) returning said deposit of said first user to his account in said computer system from said custodian account if step (j) yields a positive match;
(l) receiving said first secret code from said second user and comparing it with said first secret code stored in the said computer system; and
(m) returning the deposit of said seller to his account in said computer system from said custodian account if step (l) yields a positive match.

17. The method according to claim 16, wherein step (e) and step (f) further comprises:
(a) using a pseudo random number generator;
(b) using a universally unique identifier generator;
(c) using SHA1 hash functions;
(d) using MD5 hash functions;
(e) using other suitable random number generators;
(f) using other suitable hash functions; or
(g) using other suitable cryptographic functions.

18. The method according to claim 16, wherein step (g) and step (h) further comprises presenting said secret code in a barcode format or other suitable code presentation.

19. A method of returning deposits to users using a computer system over a global network, comprises:
(a) receiving a deposit from a first user of a transaction;
(b) transferring the amount of said deposit from the account of said first user in the said computer system or from other funding sources of said first user to a custodian account;
(c) receiving a deposit from a second user that is a counterparty of said first user of said transaction in said transaction;
(d) transferring the amount of said deposit of said second user from the account of said second user in the said computer system or from other funding sources of said second user to said custodian account or to a separate custodian account;
(e) receiving from said first user an instruction of conditionally releasing said deposit of said second user;
(f) receiving from said second user an instruction of conditionally releasing the deposit of said first user;
(g) if both steps (e) and (f) are performed, returning the deposit of said first user from said custodian account to his account in said computer system and returning the deposit of said second user from said custodian account to his account in the said computer system;
(h) returning the deposit of said second user from said custodian account to said second user's account in said computer system if step (e) is performed and if the deposit of said first user has already been returned to said first user's account in said computer system;
(i) returning the deposit of said first user from said custodian account to said first user's account in said computer system if step (f) is performed and if the deposit of said second user has already been returned to said second user's account in said computer system.
